(19) United States
(12) Patent Application Publication
(10) Pub. No.: US 2006/0087101 A1
(43) Pub. Date: Apr. 27, 2006

(54) Trailer hitch and towing system with removable utility box

(76) Inventor: Jeff J. Yon, Antioch, CA (US)

Correspondence Address: Richard C. Litman;LITMAN LAW OFFICES, LTD., P.O. Box 15035, Arlington, VA, 22215, US

(21) Appl. No.: 10/969,351

(22) Filed: Oct. 21, 2004

(51) Int. Cl. B60P 3/06

(52) U.S. Cl. 280/504

(57) ABSTRACT

The trailer hitch and towing system with removable utility box is a receiver mounted removable utility box system that accepts interchangeable towing accessories and further includes a hitch pin. The towing system has a first tube with a pair of side apertures that are inserted into and aligned with the receiver tube holes of a vehicle and secured by a hitch pin. A bracket is perpendicularly mounted on top of the first tube with a generally rectangular utility box held in the bracket. A pair of hold down spring latches, perpendicularly and upwardly attached on the bracket is provided to lock the generally rectangular utility box in to the bracket. A shackle and removable screw is attached to the generally rectangular utility box, which can be used as a carrying handle or a hitch accessory.

### BACKGROUND OF THE INVENTION

1. Field of the Invention

The present invention relates to a hitching accessory. More particularly, the invention is a receiver mounted removable utility box system that accepts interchangeable towing accessories.

2. Description of the Related Art

Trucks, sport utility vehicles (“SUV's”), cars, All Terrain Vehicles (“ATV's”), agricultural equipment and other types of vehicles are often provided with a receiver to accommodate a trailer hitch or towing assembly. Drivers of vehicles engaged in towing often require additional tools or towing accessories that must be stored in the vehicle. Where to place tools and towing accessories has long presented a problem. Although cars and trucks have storage space it is often undesirable to place dirty or cumbrous accessories in the storage space. Agricultural equipment and ATV's are often not provided with any storage at all. Further, in the case of an ATV, a heavy toolbox mounted to the frame of the ATV would raise the center of gravity of the ATV and subject the driver to rollovers. Vehicle users want the convenience of having a toolbox or utility box at their disposal but often do not want it inside the vehicle where it might roll around and damage the interior of the vehicle.

One option is to build the toolbox in to the trailer but this has the disadvantage that a driver using multiple trailers would constantly be moving his tools from one trailer to another, and in applications such as pulling a stranded vehicle out of the mud, the tools would not be available at all. At times when a user wishes to carry his tools away from a vehicle a toolbox built in to a trailer would not be effective.

Some relevant ideas put forward to address these problems include the following: United States Patent Application Publication No. 2004/0032112 published on Feb. 19, 2004, outlines the use of a hitch and receiver system that provides an additional vertical box receiver when a conventional box receiver of the vehicle hitch is in use to provide draw bar support for the hitch ball. In a second embodiment, an additional horizontal box receiver is also provided for the hitch and receiver system. The additional box receivers are used to hold and support various accessory devices.

U.S. Pat. No. 4,570,986 issued to Sams on Feb. 18, 1986, outlines the use of a bumper assembly for a vehicle having a front wall member and an attached bottom wall member supporting two vertical pins. Two tool boxes each include a well to receive a pin for support on the bottom wall member in a manner to allow each box to be pivoted outward away from the front wall member to allow access to the box interior.

U.S. Pat. No. 5,038,983 issued to Tomososki on Aug. 13, 1991, outlines the use of a cargo carrier for use on the outside of a vehicle having a trailer hitch receiver that includes a tub, a rigid bracket for supporting the tub and a pair of taillights on the rear of the tub. The bracket is adapted at the lower end for insertion into the receiver for supporting the carrier without attachment to the bumper or frame of the vehicle.

U.S. Pat. No. 5,364,142 issued to Coiner on Nov. 15, 1994, outlines the use of a heavy duty protective storage bumper mounted to the front or rear of full-sized and compact pick-up trucks, vans and 4-wheel drive vehicles or to the front of semi-tractors and other heavy equipment vehicles. The bumper provides protection for the vehicle and contains an enclosed compartment used for the storage of tools and emergency road or field equipment.

U.S. Pat. No. 5,573,162 issued to Spencer et al. on Nov. 12, 1996, outlines the use of a utility box for an ATV vehicle with a U-shaped container portion having a plurality of compartments therein. The U-shaped container portion has two securement latches pivotally secured to a front wall. A U-shaped lid portion is adapted for removable securement over the U-shaped container.

U.S. Pat. No. 6,237,823 issued to Stewart et al. on May 29, 2001, outlines the use of a carrier with a main member supported rearwardly adjacent a vehicle by a coupler of the carrier inserted into the receiver of a vehicle mounted trailer hitch. The main member includes a curved portion extending transversely and rearwardly away from a straight segment of the main member disposed transversely of the vehicle centerline. A swing arm is carried by a pivot at the extremity of the curved portion of the main member. A plate on the swing arm carries a lock assembly for securing the swing arm to and in parallel relationship with the main member during travel.

Although each of these devices are novel and useful, what is needed is a trailer hitch accessory incorporating a detachable, portable utility box which also allows the use of interchangeable towing and vehicle recovery inserts. Such an assembly would address a demand for such an assembly in the marketplace and would probably be a commercial success if developed.

None of the above inventions and patents, taken either singly or in combination, is seen to describe the instant invention as claimed. Thus an easy access toolbox solving the aforementioned problems is desired.

### SUMMARY OF THE INVENTION

The trailer hitch and towing system with removable utility box is a receiver mounted removable utility box system that accepts interchangeable towing accessories and further includes a hitch pin. The towing system has a first tube with a pair of side apertures that are inserted into and aligned with the receiver tube holes of a vehicle and secured by a hitch pin. A bracket is perpendicularly mounted on top of the first tube with a generally rectangular utility box held in the bracket. A pair of hold down spring latches, perpendicularly and upwardly attached on the bracket is provided to lock the generally rectangular utility box in to the bracket. A shackle and removable screw is attached to the generally rectangular utility box, which can be used as a carrying handle or a hitch accessory.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a trailer hitch and towing system with a removable utility box.

FIG. 2 is an exploded side view of the trailer hitch and towing system with a removable utility box.

FIG. 3 is an overhead perspective view of the trailer hitch and towing system with removable utility box.

FIG. 4 is a side perspective view of a towrope being used with the trailer hitch and towing system with removable utility box.

FIG. 5 is a front perspective view of the trailer hitch and towing system with removable utility box in an open position.

FIG. 6 is a perspective view of the removable utility box being carried by a user.

Similar reference characters denote corresponding features consistently throughout the attached drawings.

### DETAILED DESCRIPTION OF THE PREFERRED EMBODIMENTS

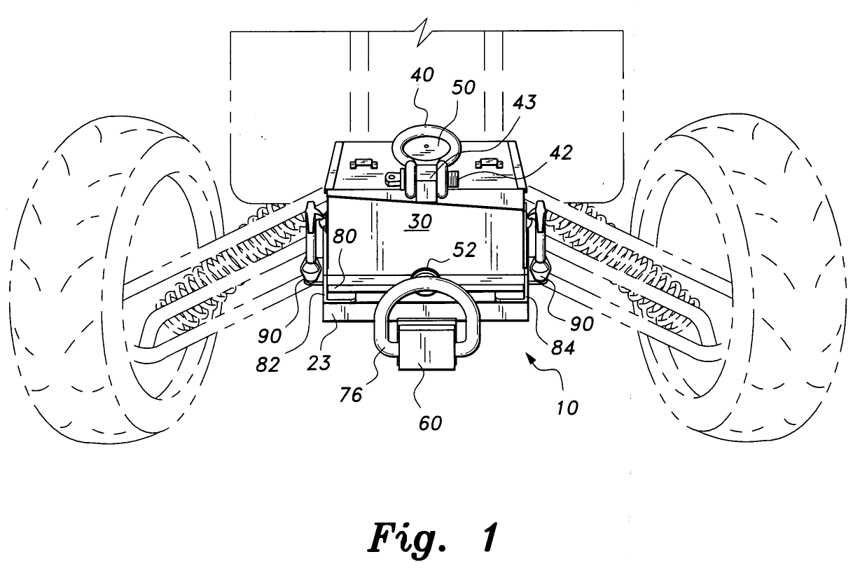

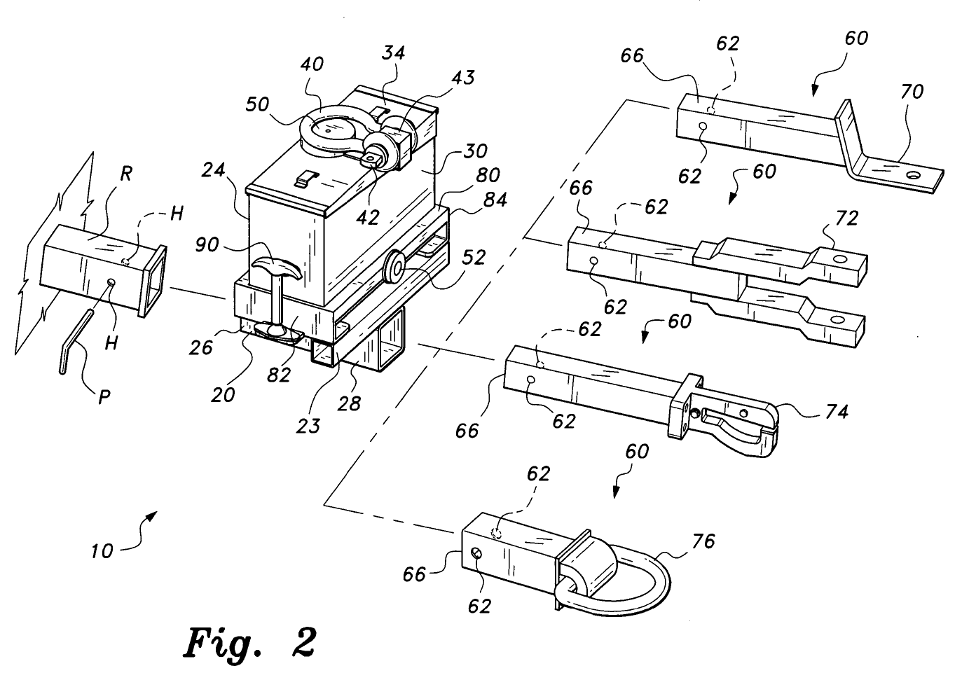

The present invention is a trailer hitch and towing system with utility box, designated generally as 10 in the drawings. The trailer hitch and towing system with utility box 10 can be used with any vehicle that has a receiver tube R, as shown in FIGS. 1 and 2.

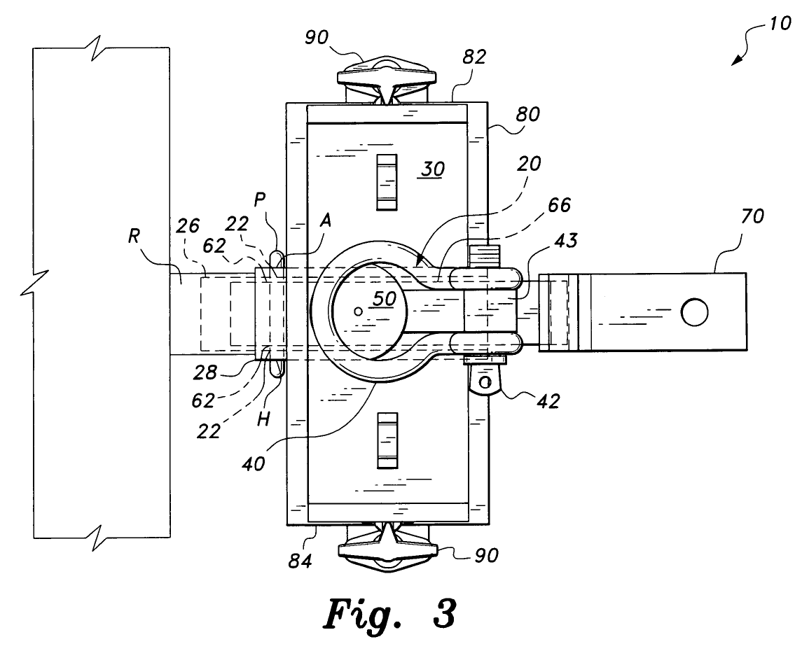

The trailer hitch and towing system with utility box 10 comprises a first tube 20 with a pair of side apertures 22, a distal end 26, and a proximal end 28. The distal end 26 is inserted into the receiver tube R and aligned so that receiver holes H align with the side apertures 22. Hitch pin P is then inserted through the receiver holes H and the side apertures 22 to secure the trailer hitch and towing system with utility box 10 to the receiver R as shown in FIGS. 2 and 3.

A second tube 23 is attached perpendicularly to the first tube 20 over the proximal end 28. A bracket 80 with two sides 82, 84 is perpendicularly mounted on top of the second tube 23. A generally rectangular utility box 30 is held in bracket 80. A shackle 40 and removable screw 42 is attached to the top of the utility box 34 through eye 43. The shackle 40 can be used as a carrying handle or a hitch accessory.

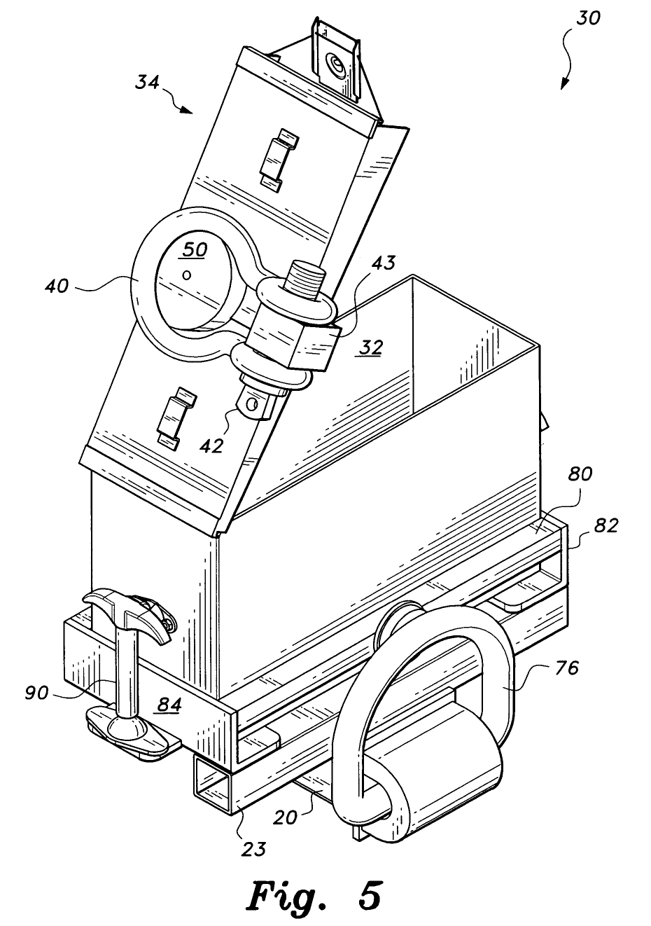

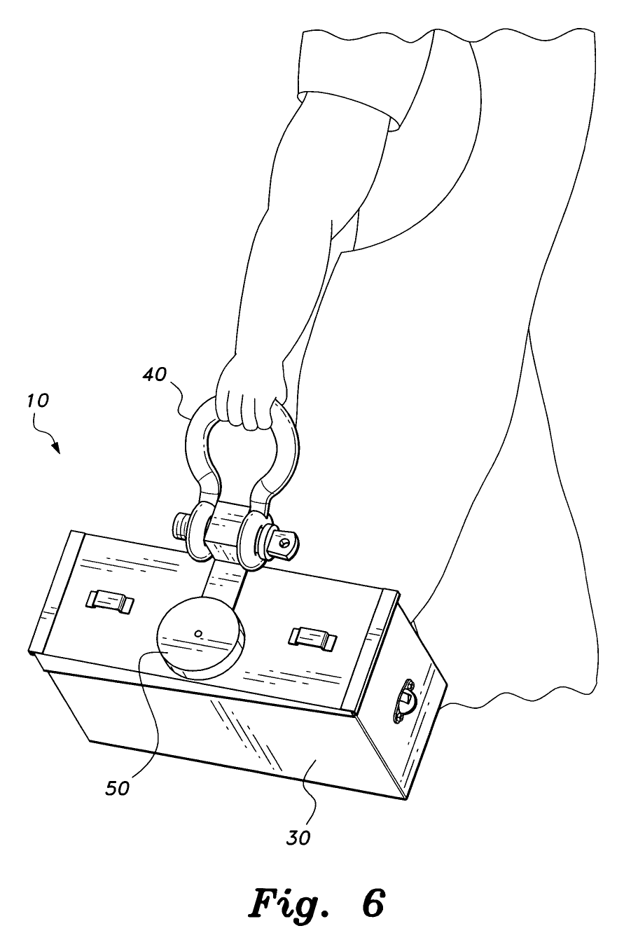

The trailer hitch and towing system with removable utility box 10 further comprises a pair of hold down spring latches 90, with one hold down spring latch 90 perpendicularly and upwardly attached on each side 82, 84 of the bracket 80. The pair of hold down spring latches 90 lock the generally rectangular utility box 30 in to the bracket 80. In this manner, the utility box 30 may be removed from the bracket 80 and carried away from the vehicle to another location, as is shown in FIG. 6. To prevent the shackle 40 from bouncing up and down against the utility box 30 while the trailer hitch and towing system with removable utility box 10 is being used a first magnet 50 is placed on top of the generally rectangular utility box 30. A second magnet 52 is placed on the bracket 80 above the hitch accessory to prevent a hitch accessory, such as a D-ring 76 shown in FIG. 5, from swinging up and down against the bracket 80 while the trailer hitch and towing system with removable utility box 10 is being used. Securing a D-ring 76 attachment by the second magnet 52 is useful in situations where ground clearance is a factor such as when taking a vehicle off road or when backing up.

As shown in FIG. 2, the trailer hitch and towing system with removable utility box 10 also includes an accessory tube and hitch accessory 60. Accessory tube and hitch accessory 60 is fitted with a pair of apertures 62 and is inserted into proximal end 28 through the length of the entire first tube 20. The accessory tube and hitch accessory 60 is then aligned with the receiver holes H of the receiver tube R and the apertures 22 of the first tube 20 and secured by hitch pin P.

Some of the more common hitch accessories contemplated for use with the present invention include a trailer ball mount 70, a clevis mount 72, a pintle hook 74 and a D-ring 76 are depicted in FIG. 2. Other hitch accessories can also be used assuming that they have a pair of corresponding apertures 62 and an accessory tube 66. The arrangement between the receiver tube R, hitch pin P, the first tube 20 and the accessory tube 66 is also shown in FIG. 3.

The trailer hitch and towing system with removable utility box 10 can be used with any standard receiver tube R and hitch pin P. The distal end 26 of the first tube 20 is first inserted into the receiver tube R and the accessory tube 66 is then inserted into the proximal end 28 of the first tube 20. The well-secured hitch accessory is then left protruding outside of the proximal end 28 of the first tube 20 and is available for use.

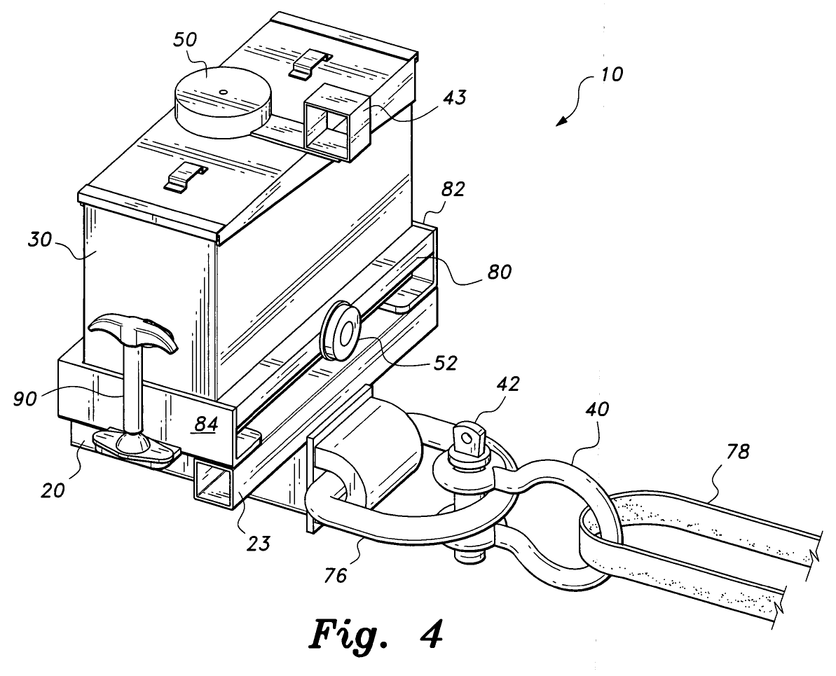

FIG. 4 depicts the use of a hitch assembly comprising a tow strap 78 with a D-ring 76. Note that the shackle 40 mounted on top of the utility box 30 can be similarly used alone as another hitch assembly or can be used in combination with a tow strap 78. As shown in FIG. 6, the shackle 40 can also be used as a handle to carry the utility box 30 when the utility box 30 has been detached from the bracket 80.

FIG. 5 depicts the generally rectangular utility box 30 detached from the receiver tube R. The generally rectangular utility box 30 has a hinged top 34 that can be opened to gain access to the interior 32, which can store items as desired by a user. Typically heavy metal items such as tools are stored in the utility box 30. The utility box 30 is shown in an open position with a shackle 40 and removable screw 42 and a D-ring 76 hitch accessory. The utility box 30 is typically not separate from the bracket 80 unless a user requires the utility box be carried to a work area while the balance of the system is still attached to the towing vehicle.

It is to be understood that the present invention is not limited to the embodiments described above, but encompasses any and all embodiments within the scope of the following claims.

I claim:

1. A trailer hitch and towing system with removable utility box for use with a vehicle receiver tube and hitch pin, comprising:
a first tube with a pair of side apertures that are inserted into and aligned with the receiver tube and hitch pin;
a second tube perpendicularly integrated on top of the first tube;
a bracket with two sides that is attached integrated on top of the second;
a generally rectangular utility box that is held in the bracket;
a pair of hold down spring latches, with one hold down spring latch perpendicularly and upwardly attached on each side of the bracket, said pair of hold down spring latches locking the generally rectangular utility box in the bracket;
a shackle and removable screw that is attached on top of the generally rectangular utility box that can be used as a carrying handle and a hitch accessory.

2. The trailer hitch and towing system with removable utility box according to claim 1, further comprising:
an accessory tube having two sides and an aperture on each side of the accessory tube attached to a hitch accessory wherein the accessory tube is inserted into and through the first tube.

3. The trailer hitch and towing system with removable utility box according to claim 1, further comprising:
a first magnet placed on top of the generally rectangular utility box to prevent movement of the shackle.

4. The trailer hitch and towing system with removable utility box according to claim 1, further comprising:
a second magnet placed on the bracket above the hitch accessory to prevent movement of a hitch accessory.

5. The assembly according to claim 1, wherein the first tube is made of steel.

6. The assembly according to claim 1, wherein the generally rectangular utility box is made of steel.

7. The assembly according to claim 1, wherein the shackle is made of steel.

8. The assembly according to claim 2, wherein the accessory tube and hitch assembly is made of steel.

9. The assembly according to claim 1, wherein the bracket is made of steel.

10. The assembly according to claim 1, wherein the hitch accessory is a trailer ball mount.

11. The assembly according to claim 1, wherein the hitch accessory is a clevis mount.

12. The assembly according to claim 1, wherein the hitch accessory is a pintle hook.

13. The assembly according to claim 1, wherein the hitch accessory is a D-ring.
